(19) United States
(12) Patent Application Publication
(10) Pub. No.: US 2013/0024804 A1
(43) Pub. Date: Jan. 24, 2013

(54) Navigation History Tracking In a Content Viewing Environment

(71) Applicants: Eitan Farchi, Pardes Hana (IL); Onn Shehory, Yahud-Monosson (IL); Moran Shochat, Zichron Ya'ayov (IL); Aviad Zlotnick, Mitzpeh Netofah (IL)

(72) Inventors: Eitan Farchi, Pardes Hana (IL); Onn Shehory, Yahud-Monosson (IL); Moran Shochat, Zichron Ya'ayov (IL); Aviad Zlotnick, Mitzpeh Netofah (IL)

(73) Assignee: International Business Machines Corporation, Armonk, NY (US)

(21) Appl. No.: 13/186,473

(22) Filed: Jul. 20, 2011

(51) Int. Cl. G06F 3/048

(52) U.S. Cl. 715/781

(57) ABSTRACT

Systems and methods for monitoring user actions, while a user is viewing first content displayed on a display screen, wherein the user views a first portion of the first content within a first context that defines scope of view for the first content; determining whether the user's actions resulted in second content being displayed on the display screen; associating the first portion of the first content with the second content; and maintaining a record of the association between the first portion of the first content and the second content.

### COPYRIGHT & TRADEMARK NOTICES

A portion of the disclosure of this patent document may contain material, which is subject to copyright protection. Certain marks referenced herein may be common law or registered trademarks of the applicant, the assignee or third parties affiliated or unaffiliated with the applicant or the assignee. Use of these marks is for providing an enabling disclosure by way of example and shall not be construed to exclusively limit the scope of the disclosed subject matter to material associated with such marks.

### TECHNICAL FIELD

The disclosed subject matter relates generally to content viewing environments and to tracking the navigation history of a user while the user is browsing over content displayed in a computing environment.

### BACKGROUND

It is not uncommon for content users and viewers to routinely switch from viewing or working on one content to viewing or working on another content. Some related contents are dynamically linked, others are not. In certain circumstances, it would be very helpful to know the path in which a user has browsed or navigated through content, especially when a direct link does not exist between said contents.

For example, in software engineering practice, code review is known to be the quality assurance method with the best return on investment. During a typical review session, a code owner frequently navigates away from the reviewed code to review other code sections, either for review or for background knowledge. Such side tracks are usually based on the code owner's valuable experience. Having the ability to later review the navigation history can add value to code review sessions.

### SUMMARY

For purposes of summarizing, certain aspects, advantages, and novel features have been described herein. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested herein.

In accordance with one embodiment, a method for monitoring user actions is provided, while a user is viewing first content displayed on a display screen, wherein the user views a first portion of the first content within a first context that defines scope of view for the first content. The method comprises determining whether the user's actions resulted in second content being displayed on the display screen; associating the first portion of the first content with the second content; and maintaining a record of the association between the first portion of the first content and the second content.

In accordance with one or more embodiments, a system comprising one or more logic units is provided. The one or more logic units are configured to perform the functions and operations associated with the above-disclosed methods. In yet another embodiment, a computer program product comprising a computer readable storage medium having a computer readable program is provided. The computer readable program when executed on a computer causes the computer to perform the functions and operations associated with the above-disclosed methods.

One or more of the above-disclosed embodiments in addition to certain alternatives are provided in further detail below with reference to the attached figures. The disclosed subject matter is not, however, limited to any particular embodiment disclosed.

### BRIEF DESCRIPTION OF THE DRAWINGS

The disclosed embodiments may be better understood by referring to the figures in the attached drawings, as provided below.

FIG. 1 illustrates an exemplary computing environment in accordance with one or more embodiments, wherein a user navigates between content displayed on a screen.

FIG. 2 is an exemplary block diagram of a method of tracking navigation history of a user among content, in accordance with one embodiment.

FIGS. 3A and 3B are block diagrams of hardware and software environments in which the disclosed systems and methods may operate, in accordance with one or more embodiments.

Features, elements, and aspects that are referenced by the same numerals in different figures represent the same, equivalent, or similar features, elements, or aspects, in accordance with one or more embodiments.

### DETAILED DESCRIPTION OF EXAMPLE EMBODIMENTS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

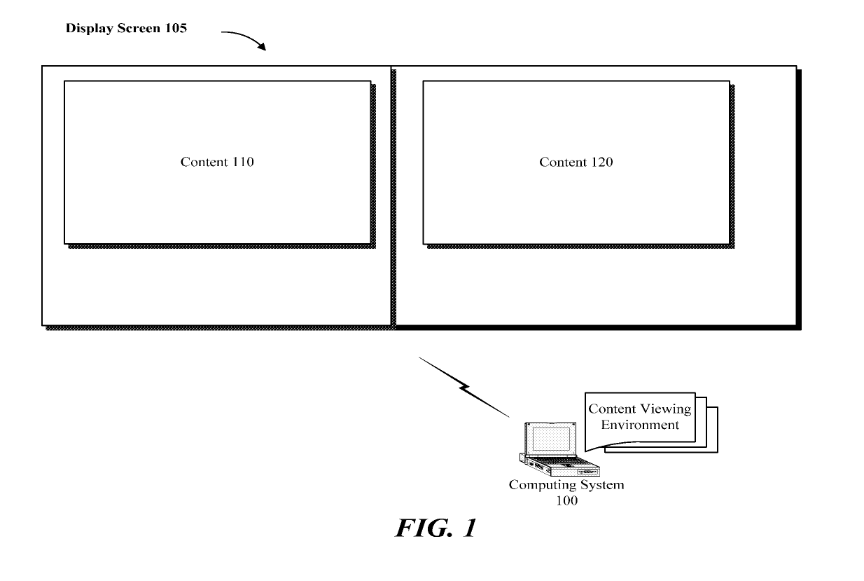

Referring to FIG. 1, an exemplary content viewing environment is illustrated in which a user may use a computing system 100 to view content displayed on a display screen 105. As shown, the user may be viewing first content 110 and then switch to viewing a second content 120 and so on. In accordance with one embodiment, it is desirable to implement a tool that is useful in tracking the navigation history of a user between content, so that during a future review of the first content 110, one is able to determine that the previous user also viewed the second content 120.

In accordance with one embodiment, the above-noted tool is implemented in the context of reviewing program code, which is provided in the following as an example. It is noteworthy, however, that this example should not be construed as limiting the scope of the subject matter claimed here to the particular context or details. In other words, other than code review, the disclosed concepts and features may be also applicable in other contexts and environments in which a user views and navigates from one content to another.

In one implementation, while a user is reviewing program code, a history of the decisions made by the user to look at any artifact while the code is being reviewed or developed is tracked and recorded by the subject tracking tool. Optionally, the tracking also records any links (i.e., association or relations) between the reviewed artifacts. Depending on the availability of resources, the tool may be accessed or made available for use over a distributed computing environment so that the navigation history for multiple reviewers or developers of a particular program code is tracked separately.

The recorded history of the navigation between the artifacts may be later used in association with reviewing the program code to determine how a previous user or users navigated among different artifacts while viewing or editing different segments of the program code. Accordingly, the tracking data may be used during subsequent viewings of the same program code or code artifacts to display a list of most popular navigation routs, or most popular artifacts viewed while viewing, editing or reviewing a particular code segment.

Optionally, in some embodiments, one or more full navigation paths to popular content or artifacts may be displayed or provided (e.g., in a submenu or a portion of the screen). In a subsequent review session, the tracking tool may be also utilized to suggest certain navigation paths, content or artifacts in the code as highly trafficked content that may be worthy of additional or more scrutinized review.

Accordingly, in one embodiment, the tracking tool is devised to use the recorded navigation history for a program code to display paths or other code sections that are associated with a currently displayed segment of the program code. Depending on implementation, a list of most-navigated-to places associated with the displayed program code segments may be provided. In addition, the most popular navigation artifacts or paths associated with the displayed code segment may be provided.

In one embodiment, the recorded navigation history may be also used to provide a ranked list of the highly associated code segments or artifacts. An artifact, depending on the context of user viewing or navigation may be one or more characters, letters, lines, paragraphs, basic blocks, functions, objects, or other segments of the program code under review. In a broader application, the tool may be used to track navigation in any type of content that includes segments, including text files, audio or video files, etc.

For example, the tool may be used to track user navigation between content displayed on the display screen which may include any type of content, such as a webpage, streaming media, etc. A viewer may interact with the tracking tool to start tracking when he wishes to, and also stop the tracking at a later time. Thus, when the tracking option is on, segments of the code or other form of content that are displayed on the screen are monitored. If the user branches to view other content than what is displayed at the time, then the tracking tool records that branching and indicates the other content that was viewed.

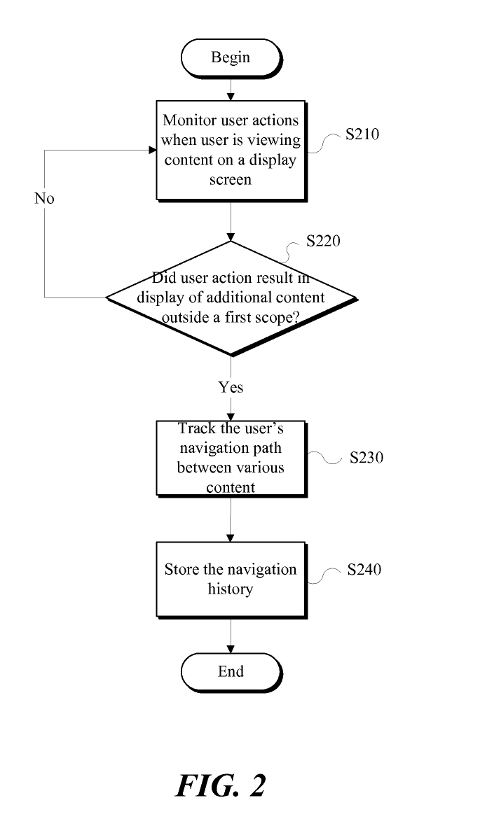

Referring to FIG. 2, for example, the tracking tool in one embodiment is implemented to monitor user actions when the user is viewing first content on a display screen 105 (S210). If it is determined that the user action resulted in displaying of additional content outside a first scope (i.e., content other than the first content) (S220), then the user navigation path from the first content to the additional content is tracked (S230). The content navigation history of the user is thus stored in a data storage medium (S240).

When the same user or other users review the same content, the tracking data (i.e., the content navigation history) associated with the tracked content is used to display the additional content that were reviewed by the user. Dynamic links may be also provided to allow the user to jump to the additional content by way of interacting with the dynamic link, for example.

For illustration, consider a scenario where the subject tool is used to record the navigation history of a user reading an electronic book. Assume that paragraphs 14 to 16 of the book are displayed on the display screen and at that time the user decides to look up the meaning of a word in paragraph 15 in an online dictionary. When the user views the content in the online dictionary for the target word, then the tool records an association between paragraphs 14 to 16 and the page on the online dictionary that was viewed by the user.

In one embodiment, the user may be given the authority or the option to provide a more pin-point association between the content. In the above example, the user may use the cursor or other tool or device to, for example, select the word that the user is looking up on the online dictionary. In this manner, the tool would be able to record a more specific association between the word being looked up and the corresponding page on the online dictionary, as opposed to recording the more general association between the paragraphs displayed on the reader and the related online content.

As provided earlier, an on/off switch or other similar means may be also provided to the user to turn the tracking on and off, depending on the need for privacy or other criteria. In contrast to current web browsing tracking technology which is useful for monitoring the browsing history of a user among various web pages, the subject tool may be utilized to track the navigation history of the user across different applications and platforms so long as the related content is displayable on the display screen, while the tracking is on and further provide statistically generated results that provide meaningful information about the degree, frequency or the level of associations or relationships among the tracked content.

For example, in one or more embodiments, a filtering or sorting feature may be provided to allow selective extraction of collected navigation data. For instance, the navigation results may be provided based on one or more of the following: viewing time history (e.g., display the oldest or the newest content viewed first or display content viewed during a selected time period first), viewer identity (e.g., display content viewed by certain user or users first), viewing frequency (e.g., display content that were viewed by most users first), viewing length (e.g., display content that were viewed for the longest accumulated time first), relevance (e.g., display contents that are most relevant in terms of a defined context or category first).

It is noted that, in some embodiments, tracking is associated with content displayed on the screen, and not a logical entity or object. It is further noted that the examples provided above are for the purpose of illustration and should not be construed as limiting the scope of the claimed subject matter to the specific details. For example, instead of sorting a filtering feature may be utilized to show content viewed by a certain user only, if so elected, without necessarily providing a sorting order for other users. One skilled in the art would appreciate that other similar or related features may be implemented to provide additional utility or more refined features.

In different embodiments, the claimed subject matter may be implemented as a combination of both hardware and software elements, or alternatively either entirely in the form of hardware or entirely in the form of software. Further, computing systems and program software disclosed herein may comprise a controlled computing environment that may be presented in terms of hardware components or logic code executed to perform methods and processes that achieve the results contemplated herein. Said methods and processes, when performed by a general purpose computing system or machine, convert the general purpose machine to a specific purpose machine.

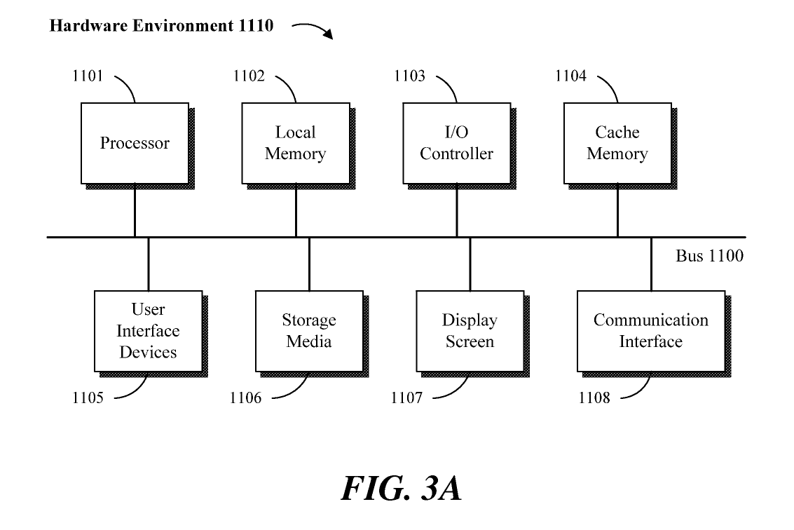

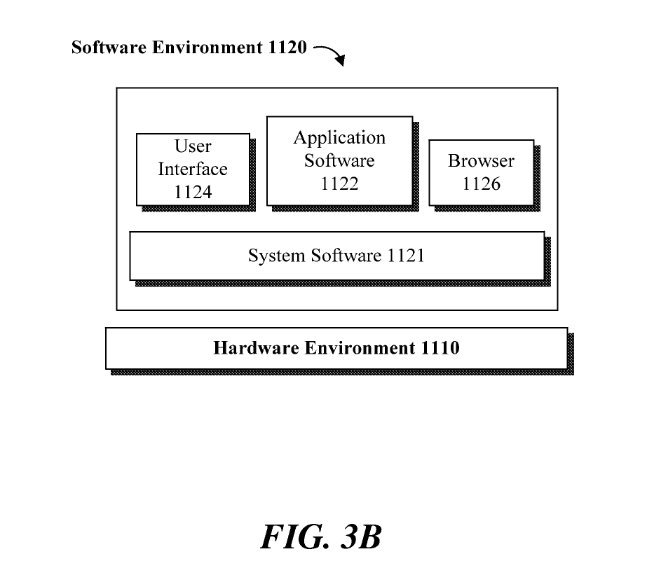

Referring to FIGS. 3A and 3B, a computing system environment in accordance with an exemplary embodiment may be composed of a hardware environment 1110 and a software environment 1120. The hardware environment 1110 may comprise logic units, circuits or other machinery and equipments that provide an execution environment for the components of software environment 1120. In turn, the software environment 1120 may provide the execution instructions, including the underlying operational settings and configurations, for the various components of hardware environment 1110.

Referring to FIG. 3A, the application software and logic code disclosed herein may be implemented in the form of computer readable code executed over one or more computing systems represented by the exemplary hardware environment 1110. As illustrated, hardware environment 110 may comprise a processor 1101 coupled to one or more storage elements by way of a system bus 1100. The storage elements, for example, may comprise local memory 1102, storage media 1106, cache memory 1104 or other computer-usable or computer readable media. Within the context of this disclosure, a computer usable or computer readable storage medium may include any recordable article that may be utilized to contain, store, communicate, propagate or transport program code.

A computer readable storage medium may be an electronic, magnetic, optical, electromagnetic, infrared, or semiconductor medium, system, apparatus or device. The computer readable storage medium may also be implemented in a propagation medium, without limitation, to the extent that such implementation is deemed statutory subject matter. Examples of a computer readable storage medium may include a semiconductor or solid-state memory, magnetic tape, a removable computer diskette, a random access memory (RAM), a read-only memory (ROM), a rigid magnetic disk, an optical disk, or a carrier wave, where appropriate. Current examples of optical disks include compact disk, read only memory (CD-ROM), compact disk read/write (CD-R/W), digital video disk (DVD), high definition video disk (HD-DVD) or Blue-Ray™ disk.

In one embodiment, processor 1101 loads executable code from storage media 1106 to local memory 1102. Cache memory 1104 optimizes processing time by providing temporary storage that helps reduce the number of times code is loaded for execution. One or more user interface devices 1105 (e.g., keyboard, pointing device, etc.) and a display screen 1107 may be coupled to the other elements in the hardware environment 1110 either directly or through an intervening I/O controller 1103, for example. A communication interface unit 1108, such as a network adapter, may be provided to enable the hardware environment 1110 to communicate with local or remotely located computing systems, printers and storage devices via intervening private or public networks (e.g., the Internet). Wired or wireless modems and Ethernet cards are a few of the exemplary types of network adapters.

It is noteworthy that hardware environment 1110, in certain implementations, may not include some or all the above components, or may comprise additional components to provide supplemental functionality or utility. Depending on the contemplated use and configuration, hardware environment 1110 may be a desktop or a laptop computer, or other computing device optionally embodied in an embedded system such as a set-top box, a personal digital assistant (PDA), a personal media player, a mobile communication unit (e.g., a wireless phone), or other similar hardware platforms that have information processing or data storage capabilities.

In some embodiments, communication interface 1108 acts as a data communication port to provide means of communication with one or more computing systems by sending and receiving digital, electrical, electromagnetic or optical signals that carry analog or digital data streams representing various types of information, including program code. The communication may be established by way of a local or a remote network, or alternatively by way of transmission over the air or other medium, including without limitation propagation over a carrier wave.

As provided here, the disclosed software elements that are executed on the illustrated hardware elements are defined according to logical or functional relationships that are exemplary in nature. It should be noted, however, that the respective methods that are implemented by way of said exemplary software elements may be also encoded in said hardware elements by way of configured and programmed processors, application specific integrated circuits (ASICs), field programmable gate arrays (FPGAs) and digital signal processors (DSPs), for example.

Referring to FIG. 3B, software environment 1120 may be generally divided into two classes comprising system software 1121 and application software 1122 as executed on one or more hardware environments 1110. In one embodiment, the methods and processes disclosed here may be implemented as system software 1121, application software 1122, or a combination thereof. System software 1121 may comprise control programs, such as an operating system (OS) or an information management system, that instruct one or more processors 1101 (e.g., microcontrollers) in the hardware environment 1110 on how to function and process information. Application software 1122 may comprise but is not limited to program code, data structures, firmware, resident software, microcode or any other form of information or routine that may be read, analyzed or executed by a processor 1101.

In other words, application software 1122 may be implemented as program code embedded in a computer program product in form of a computer-usable or computer readable storage medium that provides program code for use by, or in connection with, a computer or any instruction execution system. Moreover, application software 1122 may comprise one or more computer programs that are executed on top of system software 1121 after being loaded from storage media 1106 into local memory 1102. In a client-server architecture, application software 1122 may comprise client software and server software. For example, in one embodiment, client software may be executed on a client computing system that is distinct and separable from a server computing system on which server software is executed.

Software environment 1120 may also comprise browser software 1126 for accessing data available over local or remote computing networks. Further, software environment 1120 may comprise a user interface 1124 (e.g., a graphical user interface (GUI)) for receiving user commands and data. It is worthy to repeat that the hardware and software architectures and environments described above are for purposes of example. As such, one or more embodiments may be implemented over any type of system architecture, functional or logical platform or processing environment.

It should also be understood that the logic code, programs, modules, processes, methods and the order in which the respective processes of each method are performed are purely exemplary. Depending on implementation, the processes or any underlying sub-processes and methods may be performed in any order or concurrently, unless indicated otherwise in the present disclosure. Further, unless stated otherwise with specificity, the definition of logic code within the context of this disclosure is not related or limited to any particular programming language, and may comprise one or more modules that may be executed on one or more processors in distributed, non-distributed, single or multiprocessing environments.

As will be appreciated by one skilled in the art, a software embodiment may include firmware, resident software, micro-code, etc. Certain components including software or hardware or combining software and hardware aspects may generally be referred to herein as a “circuit,” “module” or “system.” Furthermore, the subject matter disclosed may be implemented as a computer program product embodied in one or more computer readable storage medium(s) having computer readable program code embodied thereon. Any combination of one or more computer readable storage medium(s) may be utilized. The computer readable storage medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing.

In the context of this document, a computer readable storage medium may be any tangible medium that can contain, or store a program for use by or in connection with an instruction execution system, apparatus, or device. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable storage medium may be transmitted using any appropriate medium, including but not limited to wireless, wireline, optical fiber cable, RF, etc., or any suitable combination of the foregoing. Computer program code for carrying out the disclosed operations may be written in any combination of one or more programming languages, including an object oriented programming language such as Java, Smalltalk, C++ or the like and conventional procedural programming languages, such as the “C” programming language or similar programming languages.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Certain embodiments are disclosed with reference to flowchart illustrations and/or block diagrams of methods, apparatus (systems) and computer program products according to embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures.

For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The claimed subject matter has been provided here with reference to one or more features or embodiments. Those skilled in the art will recognize and appreciate that, despite of the detailed nature of the exemplary embodiments provided here, changes and modifications may be applied to said embodiments without limiting or departing from the generally intended scope. These and various other adaptations and combinations of the embodiments provided here are within the scope of the disclosed subject matter as defined by the claims and their full set of equivalents.

What is claimed is:

1. A method implemented for execution on a computing machine for tracking navigation history, the method comprising:
monitoring user actions, while a user is viewing first content displayed on a display screen, wherein the user views a first portion of the first content within a first context that defines scope of view for the first content;
determining whether the user's actions resulted in second content being displayed on the display screen;
associating the first portion of the first content with the second content; and
maintaining a record of the association between the first portion of the first content and the second content.

2. The method of claim 1, wherein after displaying of the second content on the display screen, the user returns to viewing the first content, and wherein the monitoring of the user actions continues to maintain records of the user's navigation history from viewing one or more portions of the first content to viewing corresponding secondary content respectively viewed in association with said one or more portions of the first content.

3. The method of claim 2, wherein the secondary content is outside the first context that defines the scope of view for the first content.

4. The method of claim 2, wherein the records of user's navigation history between different content is utilized to build a repository of relationships which is used to provide a second user with at least one of information about or links to the secondary content viewed by a first user in association with viewing the first content.

5. The method of claim 4, wherein the information about the secondary content viewed by the first user is provided for display to the second user when the corresponding portions of the first content are provided for display to the second user.

6. The method of claim 5, wherein the secondary content are filtered or sorted in accordance to one or more of the following factors: viewing time, viewer identity, viewing frequency, viewing length, and relevance.

7. The method of claim 1, wherein the user controls when the monitoring of the user actions starts or ends.

8. The method of claim 1, wherein the user controls a point of association in the first portion of the first content to a point of association in the second content.

9. The method of claim 8, wherein the point of association in the first content comprises one or more text characters.

10. The method of claim 8, wherein the point of association in the second content comprises one or more text characters.

11. A system for tracking navigation history, the system comprising:
one or more processors coupled to one or more data storage media and configured for tracking navigation history of a user among content;
a logic unit for monitoring user actions, while a user is viewing first content displayed on a display screen, wherein the user views a first portion of the first content within a first context that defines scope of view for the first content;
a logic unit for determining whether the user's actions resulted in second content being displayed on the display screen;
a logic unit for associating the first portion of the first content with the second content; and
a logic unit for maintaining a record of the association between the first portion of the first content and the second content.

12. The system of claim 11, wherein after displaying of the second content on the display screen, the user returns to viewing the first content, and wherein the monitoring of the user actions continues to maintain records of the user's navigation history from viewing one or more portions of the first content to viewing corresponding secondary content respectively viewed in association with said one or more portions of the first content.

13. The system of claim 12, wherein the secondary content is outside the first context that defines the scope of view for the first content.

14. The system of claim 12, wherein the records of user's navigation history between different content is utilized to build a repository of relationships which is used to provide a second user with at least one of information about or links to the secondary content viewed by a first user in association with viewing the first content.

15. The system of claim 14, wherein the information about the secondary content viewed by the first user is provided for display to the second user when the corresponding portions of the first content are provided for display to the second user.

16. The system of claim 15, wherein the secondary content are filtered or sorted in accordance to one or more of the following factors: viewing time, viewer identity, viewing frequency, viewing length, and relevance.

17. The system of claim 11, wherein the user controls when the monitoring of the user actions starts or ends.

18. A computer program product comprising a non-transient computer readable storage medium having a computer readable program, wherein the computer readable program when executed on a computer causes the computer to:
monitor user actions, while a user is viewing first content displayed on a display screen, wherein the user views a first portion of the first content within a first context that defines scope of view for the first content;
determine whether the user's actions resulted in second content being displayed on the display screen;
associate the first portion of the first content with the second content; and
maintain a record of the association between the first portion of the first content and the second content.

19. The computer program product of claim 18, wherein after displaying of the second content on the display screen, the user returns to viewing the first content, and wherein the monitoring of the user actions continues to maintain records of the user's navigation history from viewing one or more portions of the first content to viewing corresponding secondary content respectively viewed in association with said one or more portions of the first content.

20. The computer program product of claim 19, wherein the secondary content is outside the first context that defines the scope of view for the first content.
